(19) United States
(12) Patent Application Publication
(10) Pub. No.: US 2025/0073686 A1
(43) Pub. Date: Mar. 6, 2025

(54) PREPARATION AND PRETREATMENT TECHNIQUES OF CU/CEO2 CATALYSTS FOR LOW TEMPERATURE DIRECT DECOMPOSITION OF NOX EXHAUST GAS

(71) Applicant: THE JOHNS HOPKINS UNIVERSITY, Baltimore, MD (US)

(72) Inventors: Chao Wang, Ellicott City, MD (US); Pengfei Xie, Baltimore, MD (US)

(21) Appl. No.: 18/953,811

(22) Filed: Nov. 20, 2024

Related U.S. Application Data
(63) Continuation of application No. 16/499,561, filed on Sep. 30, 2019.
(60) Provisional application No. 62/479,874, filed on Mar. 31, 2017.

(51) Int. Cl. B01J 23/83; B01D 53/86; B01J 6/00; B01J 35/40; B01J 35/50; B01J 37/03; B01J 37/04

(52) U.S. Cl. CPC B01J 23/83; B01D 53/8628; B01J 6/001; B01J 35/40; B01J 35/50; B01J 37/031; B01J 37/04; B01D 2257/404

(57) ABSTRACT

CeO₂ nanoparticles having a copper domain disposed on at least a portion of the nanoparticle. The material can catalyze a nitrogen oxide decomposition, such as a deNₓO_{y} reaction. Methods of making and using the material are also provided.

### CROSS REFERENCE TO RELATED APPLICATIONS

This application is a Continuation of U.S. patent application Ser. No. 16/499,561, filed on Sep. 30, 2019, which claims priority to U.S. Provisional Application No. 62/479,874, filed on Mar. 31, 2017, the disclosure of which is hereby incorporated by reference.

### FIELD OF THE DISCLOSURE

The present disclosure relates to the synthesis of copper-cerium oxide nanoparticles. More particularly, the disclosure relates to copper-cerium oxide nanoparticles that can be used as deNOₓ catalysts.

### BACKGROUND OF THE DISCLOSURE

NOₓ exhaust gas, including NO, N₂O and NO₂, is a major pollutant gas emitted from automobiles and power plants using coal as fuel. NO remains to be a major environmental pollutant, which causes acid rain, photochemical smog and harmful effects on human health. The decomposition of NO is impeded with high activation energy barrier (around 150 kJ/mol), which requires high temperature for thermal NO decomposition. Hence, in order to decrease such high activation energy barrier with low energy consumption, it is necessary to develop efficient catalysts for direct NO decomposition at low temperature.

General catalytic elimination methods of NO include direct NO decomposition, selective catalytic reduction, and NO storage and reduction. Both selective catalytic reduction (SCR) and NO storage, reduction need a reducing agent such as ammonia, hydrogen, hydrocarbons (HC) and urea, which are required to precise control over the stoichiometry. Additionally, these reducing agents can cause secondary pollution. In other words, the design of engine and emission control is more complex for selective catalytic reduction and NO storage, reduction. In contrast, direct NO decomposition is simple and environmental friendly way for NO decomposition since no co-reactant is not required.

Previous catalysts for direct NO decomposition have metal oxides, perovskite-type catalysts and zeolitic catalysts. Several transitional metal oxides have been studied to directly decompose NO, and among them Co₃O₄ was one of the most active catalysts, while high temperature (above 600° C.) was required to obtain high NO conversion (above 80%). Perovskite-type catalysts with an ABO₃ chemical composition contain certain amount of oxygen-deficient sites, which could absorb NO easily, so such catalysts also had good performance for NO decomposition. LaMnO₃ catalyst series, which usually were doped with other metals (Ba, Mn et al.) showed high activity for direct NO decomposition, and these catalysts could decompose NO by 80% at 700° C. Compare with the above oxide catalysts, Cu containing zeolitic catalysts, particularly CuZSM-5, were more active, due to contained specific active Cu dimmers. Prior studies reported CuZSM-5 with Si/Al ratio of 12 could decomposed NO by 80% at 400° C., which was much more active than reported oxide catalyst (Iwamoto et al. and Ishihara et al.).

The cold start of vehicles produces significant emission of pollutants. One such pollutant is NOₓ. However, existing de-NOₓ catalysts are inactive at cold temperatures. Prior art NSR catalysts (e.g., Pt/BaO/Al₂O₃) require temperatures in excess of 300° C. Prior art SCR catalysts require a supply of reducing agent (e.g., urea) and temperatures in excess of 200° C. See FIGS. 10-12.

Even though zeolite catalysts can directly decompose NO totally at around 450° C., however, the total decomposition temperature for selective catalytic reduction method is as low as 150° C. to 250° C., which still possesses advantage in energy consumption. Therefore, in order to fully develop the advantage of direct NO decomposition, it is necessary to develop new catalysts, which can direct decompose NO at possible lower temperature.

### SUMMARY OF THE DISCLOSURE

In an aspect, the present disclosure provides nanoparticles and compositions comprising nanoparticles. The nanoparticles can be used as catalysts. The nanoparticles can be made by a method of the present disclosure. In an example, a nanoparticle or nanoparticles are made by a method of the present disclosure. Various examples of nanoparticles and compositions are also referred to herein as copper doped cerium oxide nanoparticles and catalyst.

In an example, the present disclosure provides a CeO₂ nanoparticle or nanoparticles having domains of one or more copper species (e.g., aqueous-insoluble copper(II) salts (e.g., copper carbonate), copper oxide, copper hydroxide, copper, and combinations thereof) and/or one or more alloy thereof disposed on at least a portion of a surface of the CeO₂ nanoparticles. In another example, one or more of the copper domains comprise copper metal.

In an aspect, the present disclosure provides methods of using the nanoparticle/nanoparticles of the present disclosure. The nanoparticle/nanoparticles can be used as catalysts (in SCR and NSR reactions). For example, the nanoparticle/nanoparticles are used in methods of decomposing one or more nitrogen oxides. When describing different NO-based gases, NOₓ and NₓO_{y} may be used interchangeably.

In an example, catalysts (e.g., nanoparticle(s) or materials) are synthesized in a precipitation method described herein followed by annealing. Catalysts were activated by hydrogen and helium thermal pretreatment. For example, under 300° C., 5% Cu/CeO₂ was capable of sustain 20 hours of nearly 100% conversion of NO exhaust gas with almost full selectivity to N₂. After deactivation, 5% Cu/CeO₂ catalyst can be easily regenerated by H₂ or CO. The addition of oxygen could reduce the lifetime of catalyst, but the catalyst also is able to be easily regenerated and shows desirable deNOₓ performance.

### BRIEF DESCRIPTION OF THE FIGURES

For a fuller understanding of the nature and objects of the disclosure, reference should be made to the following detailed description taken in conjunction with the accompanying figures.

FIG. 1 shows a preparation procedure and pretreatment method for Cu/CeO₂ catalyst.

FIG. 2 shows TEM images of commercial CeO₂ and Cu precipitate CeO₂ samples. a) Commercial CeO₂; b) 2% Cu/CeO₂; c) 5% Cu/CeO₂; d) 8% Cu/CeO₂.

FIG. 3 shows XRD data of commercial CeO₂ and 2%, 5% and 8% Cu precipitate CeO₂ samples, respectively.

FIG. 4 shows an industrial design of deNOₓ process utilizing Cu/CeO₂ catalyst.

FIG. 5 shows catalytic reaction results of NO decomposition over commercial CeO₂, 5% Cu/Al₂O₃ and 5% Cu/CeO₂ catalysts at 30° C.

FIG. 6 shows catalytic reaction results of NO decomposition over 5% Cu/CeO₂ catalyst in the present disclosure at 30° C. and 300° C.

FIG. 7 shows catalytic reaction results of NO decomposition over 2% Cu/CeO₂, 5% Cu/CeO₂, and 8% Cu/CeO₂ catalysts in the present disclosure at 300° C.

FIG. 8 shows regeneration of 5% Cu/CeO₂ catalyst by H₂ reduction and catalytic NO decomposition results at 30° C.

FIG. 9 shows regeneration of 5% Cu/CeO₂ catalyst by H₂ or CO reduction and catalytic NO decomposition results in presence of 5% O₂ at 30° C.

FIGS. 10, 11, and 12 show NOₓ conversion data for prior catalysts.

FIGS. 13-21 show various examples of use of nanoparticle(s) or materials of the present disclosure in deNOₓ methods.

FIG. 22 shows XRD data. There is no peak for Cu, Pt, or Zr observed.

FIG. 23 shows TEM micrographs. (A) CuCeOₓ. (B) CuPtCeOₓ. (C) CuZrCeO₂. (D) Magnification of (C). Commercial CeO₂ support is around 20 nm, CeZrOₓ is around 200 nm and CeZrOₓ has mesopores (including N₂ adsorption-desorption results).

FIG. 24 shows BET surface area of various catalysts. CuZrCeOₓ has the highest surface area.

FIG. 25 shows NO storage and reduction (NSR) on CuCeOₓ. Lean gas is 500 ppm NO and 5% O₂ and rich gas is 500 ppm NO+1% H₂.

FIG. 26 shows NSR on CuCeO₂. Lean gas is 500 ppm NO and 5% O₂ and rich gas is 500 ppm NO+1% CO.

FIG. 27 shows deNOₓ ability in real vehicle exhaust by doping CeOₓ with Zr and adding Pt to Cu. At 100° C., NO conversion on CuCeOₓ, CuPtCeOₓ, and CuZrCeOₓ were 33.3%, 43.3%, AND 53.7%.

FIG. 28 shows a comparison of deNOₓ catalysts.

FIG. 29 shows the deNOₓ activities of three way catalysts.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The present disclosure provides Cu/CeO₂ nanoparticles, which can be used as deNOₓ catalysts, and preparation and pretreatment methods for same, and methods of use of the same. It further describes industrial design of catalytic processes and catalytic performance of the nanoparticles.

In an aspect, the present disclosure provides nanoparticles and compositions comprising nanoparticles. The nanoparticles can be used as catalysts. The nanoparticles can be made by a method of the present disclosure. In an example, a nanoparticle or nanoparticles are made by a method of the present disclosure. Various examples of nanoparticles and compositions are also referred to herein as copper doped cerium oxide nanoparticles and catalyst.

In an example, the present disclosure provides a CeO₂ nanoparticle or nanoparticles having domains of one or more copper species (e.g., aqueous-insoluble copper(II) salts (e.g., copper carbonate), copper oxide, copper hydroxide, copper, and combinations thereof) and/or one or more alloy thereof disposed on at least a portion of a surface of the CeO₂ nanoparticles. In another example, one or more of the copper domains comprise copper metal.

In an example, a material comprising one or more nanoparticles, wherein the nanoparticles are CeO₂ nanoparticles, which comprise one or more additional metals, having domains of one or more copper species (e.g., aqueous-insoluble copper(II) salts (e.g., copper carbonate), copper oxide, copper hydroxide, copper, and combinations thereof) and/or alloys thereof disposed on at least a portion of a surface of the CeO₂ nanoparticles. In another example, one or more of the copper domains comprise copper metal.

CeO₂ nanoparticles can have various compositions. A CeO₂ nanoparticle or nanoparticles can further comprise one or more additional metals (e.g., zirconium, zinc, magnesium, and combinations thereof). In various examples, the nanoparticle/nanoparticles is/are binary oxides such as, for example, Zr—Ce—O, Zn—Ce—O, and Mg—Ce—O. Suitable examples of CeO₂ nanoparticles can be made by methods known in the art and are commercially available.

Copper species are highly dispersed on CeO₂ nanoparticles. The copper species can be discrete domains. The size of copper species (e.g., domains of copper species) are subnanometer. The copper species can be alloys with one or more additional metals in varying amounts.

Copper (e.g., in an oxidized/ionic form and/or metallic form) can be present at various amounts in the nanoparticle/nanoparticles at various amounts. In various examples, copper is present at 0.001% by weight to 8% by weight, based on the total weight of the nanoparticle(s), including all values to 0.001% and ranges therebetween. In various other examples, copper is present at e.g., 2% by weight to 8% by weight or 4% by weight to 6% by weight, based on the total weight of the nanoparticle(s).

The nanoparticle/nanoparticles can comprise copper species that further comprise one or more additional non-copper metals. The one or more additional non-copper metals can be present as an alloy with the copper in the copper species. In various examples, the one or more additional non-copper metals is gold, silver, platinum, rhodium, palladium, iridium, rhodium, iron, cobalt, nickel, zirconium, or a combination thereof.

The nanoparticle/nanoparticles can be of various sizes. In various examples, the nanoparticle/nanoparticles has/have a longest dimension (e.g., diameter) or average longest dimension (e.g., average diameter) of 10 nm to 30 nm, including all integer nm values and ranges therebetween. Nanoparticle size can be measured by methods known in the art. For example, nanoparticle size is measured by microscopy methods (e.g., scanning electron microscopy (SEM) or transmission electron microscopy (TEM)) or light scattering methods (e.g., dynamic light scattering (DLS)).

The nanoparticle/nanoparticles can have various morphologies. In various examples, the nanoparticles is/are spherical or nanorods.

In an example, the nanoparticle/nanoparticles are subjected to activation/pretreatment as described herein. The activated nanoparticle/nanoparticles have a Cu—Ce solid solution. The nanoparticle/nanoparticles have at least one active site (e.g., oxygen vacancy).

The nanoparticle/nanoparticles (e.g., nanoparticle/nanoparticles activated as described herein) can be used to catalyze various reactions. For example, the nanoparticle/nanoparticles catalyzes a nitrogen oxide decomposition reaction (e.g., deNₓO_{y} reaction, wherein x and y are independently 1 or 2, but not simultaneously 2).

In an aspect, the present disclosure provides methods of making nanoparticles of the present disclosure. The methods are based on deposition of copper species on cerium oxide nanoparticles.

In various examples, a method of synthesizing nanoparticle/nanoparticles, which can be present in a material, comprises: a) adding (e.g., suspending) CeO₂ (e.g., cerium oxide particles) in an aqueous medium (e.g., water such as, for example, deionized water); b) adding an aqueous-soluble copper salt (e.g., copper nitrate, copper chloride) to the aqueous medium from a) (e.g., CeO₂ suspension from a)) to form a mixture; c) adding an excess (e.g., molar excess based on the amount of copper present in the mixture) of a salt (e.g., a soluble salt) comprising an anion (e.g., carbonate anion, hydroxide ion) (e.g., sodium carbonate, sodium chloride) that forms an insoluble copper (e.g., copper(II)) salt to the mixture from b), wherein an insoluble copper (e.g., copper(II)) salt and/or copper hydroxide precipitates on at least a portion of a surface of at least a portion of the CeO₂ (e.g., cerium oxide particles) to form a solid product material; d) isolating (e.g., by filtration) the solid product material from c); c) calcining (e.g., heating in air at 400° C. for 3 h (h=hour(s)) (heating ramp 2° C./min)) the solid product material from d); and, optionally, f) graining the solid product from e) to form a material of any of the preceding claims.

Copper loading on CeO₂ can be manipulated by adding different amount of copper salt(s) (e.g., nitrate salt(s)) into the CeO₂-copper nitrate solution mixture. There was no observation on morphology change after copper precipitation.

The salt is present in an excess based on the amount of copper present in the mixture. Without intending to be limited by any particular theory, it is considered that that salt functions as a precipitant to ensure the Cu ions are captured and deposited on the surface of CeO₂ nanoparticles.

Optionally, the solid product from d) in the example above is grained. Graining provides pellets (e.g., 40-60 mesh) of the solid product.

The solid product from d) can be subjected to conditions (e.g., pre such that an active catalyst material is provided.

In an aspect, the present disclosure provides methods of using the nanoparticle/nanoparticles of the present disclosure. The nanoparticle/nanoparticles can be used as catalysts (in SCR and NSR reactions). For example, the nanoparticle/nanoparticles are used in methods of decomposing one or more nitrogen oxides. When describing different NO-based gases, NOₓ and NₓO_{y} may be used interchangeably.

In an example, catalysts (e.g., nanoparticle(s) or materials) are synthesized in a precipitation method described herein followed by annealing. Catalysts were activated by hydrogen and helium thermal pretreatment. For example, under 300° C., 5% Cu/CeO₂ was capable of sustain 20 hours of nearly 100% conversion of NO exhaust gas with almost full selectivity to N₂. After deactivation, 5% Cu/CeO₂ catalyst can be easily regenerated by H₂ or CO. The addition of oxygen could reduce the lifetime of catalyst, but the catalyst also is able to be easily regenerated and shows desirable deNOₓ performance.

After the activation, the activated catalysts are able to catalyze deNOₓ reactions with nearly full conversion and 100% selectivity to N₂ at ambient temperature (30° C.) for considerable amount of time (0.5 h to 20 h).

In various examples, a method of decomposing one or more nitrogen oxides (e.g., NₓO_{y}, wherein x and y are independently 1 or 2, but not simultaneously 2) using the nanoparticle/nanoparticles or material of the present disclosure comprises: a) contacting (e.g., flushing the atmosphere in which the material is present) nanoparticle(s) of the present disclosure or a material of the present disclosure or nanoparticle(s) or a material made by a method of the present disclosure with a gas comprising 0 to 10% H₂ (e.g., 0.001% by volume to 100% by volume, including all 0.001% values and ranges therebetween, or 0.001% by volume to 10% by volume) in an environment at a temperature of 150° C. to 800° C., including all 0.001% values and ranges therebetween, (e.g., 300° C. to 500° C.); b) returning (e.g., cooling) the nanoparticle(s) or material from a) to room temperature (e.g., 18-25° C.); c) contacting the nanoparticle(s) or material from b) (e.g., flushing the atmosphere in which the nanoparticle(s) or material is/are present) with helium gas; d) heating the nanoparticle(s) or material from c) to a temperature of 150° C. to 800° C., including all 0.001% values and ranges therebetween, (e.g., 300° C. to 500° C.); c) contacting the nanoparticle(s) or material from d) with the one or more nitrogen oxides (e.g., NₓO_{y}, wherein x and y are independently 1 or 2, but not simultaneously 2) at 150° C. to 800° C., including all 0.001% values and ranges therebetween, (e.g., 30° C. to 300° C.), wherein at least a portion of the one or more nitrogen oxides (e.g., NₓO_{y}, wherein x and y are independently 1 or 2, but not simultaneously 2) are decomposed (e.g., to form nitrogen gas and oxygen gas).

Optionally, a method of decomposing one or more nitrogen oxides further comprises isolation of least a portion of the decomposed one or more nitrogen oxides from the nanoparticle(s) or material. The decomposed one or more nitrogen oxides can be isolated by methods known in the art.

Copper doped cerium oxide (Cu/CeO₂) catalysts of the instant disclosure can be synthesized by precipitation methods described herein. Copper active sites are well dispersed on the surface of CeO₂ with a preparation method of the present disclosure. The nanoparticle(s) or materials have at least one active site (e.g., oxygen vacancy). The CeO₂ nanoparticles possess high oxygen storage capacity.

The as-prepared Cu/CeO₂ catalysts are capable of undergoing activation with hydrogen reduction and helium thermal pretreatment. After pretreatment (e.g., a)-d) in the method above), a Cu—Ce solid solution is formed. Without intending to be bound by any particular theory it is considered that the interface between Cu and Ce plays an important role in nitrogen oxide decomposition.

Examples 5 and 6 show that the interface between Cu and CeO₂ was created and synergistic effects between Cu and CeO₂ not only had good capacity of NO decomposition, but also was able to retard the deactivation of Cu/CeO₂. Without intending to be bound by any particular theory, it is considered that NO can be decomposed on the interface between Cu and CeO₂, and then the left adsorbed oxygen intermediate after N₂ release can be migrated to oxygen vacancies and recover active sites. Moreover, the migrated rate is expected to increase with increment of temperature, so the lifetime of Cu/CeO₂ is expected to last for nearly 20 hours.

Comparison in Example 7 show that a desirable Cu loading of Cu/CeO₂ is 5%. At too low Cu loading the Cu/CeO₂ nanoparticle have an undesirable number of active sites and at too high a Cu loading, Cu sites were aggregated, which is not favored for NO decomposition.

The nanoparticle(s) or material can be regenerated and reused in a method. Optionally, a method of decomposing one or more nitrogen oxides further comprises regeneration and, if desired, reuse of the regenerated nanoparticle(s) or material. In various examples, nanoparticle(s) or material previously used to decomposing one or more nitrogen oxides is contacted (e.g., a temperature of 300° C. to 800° C. for certain time (e.g., 0.5 h to 10 h) with a gas comprising hydrogen (e.g., a gas comprising 0.001% by volume to 100% by volume H₂ gas (e.g., 5% H₂ gas) or CO gas), where at least a portion of the copper in the material is reduced to copper metal. Examples 8 and 9 show that after deactivation, the catalyst can be regenerated. The activity and lifetime were able to recover on regeneration. In various examples, activity and/or lifetime values were recovered to 90% or greater, 95% or greater, or 99% or greater of their original values after regeneration.

A method can be carried out in various configurations. A method can be carried out as continuous process.

The steps of the methods described in the various embodiments and examples disclosed herein are sufficient to carry out the methods of the present disclosure. Thus, in various examples, a method consists essentially of a combination of the steps of the methods disclosed herein. In various other examples, a method consists of such steps.

The following Statements provide embodiments and/or examples of nanoparticles (e.g., CeO₂ nanoparticles) having domains of one or more copper species, methods of the present disclosure (e.g., methods of making materials of the present disclosure), and articles of manufacture of the present disclosure (e.g., articles of manufacture comprising one or more layers of the present disclosure):
Statement 1. A material comprising one or more nanoparticles, wherein the nanoparticles are CeO₂ nanoparticles having domains of one or more copper species (e.g., aqueous-insoluble copper(II) salts (e.g., copper carbonate), copper oxide, copper hydroxide, and combinations thereof) disposed on at least a portion of a surface of the CeO₂ nanoparticles.
Statement 2. The material of Statement 1, wherein the copper is present at 0.001% by weight to 8% by weight (e.g., 2% by weight to 8% by weight or 4% by weight to 6% by weight) based on the total weight of the nanoparticle(s).
Statement 3. The material of Statements 1 or 2, wherein the nanoparticles have a longest dimension (e.g., diameter) of 10 nm to 30 nm.
Statement 4. The material of any one of the preceding Statements, wherein the nanoparticles are spherical or nanorods.
Statement 5. The material of any one of the preceding Statements, wherein one or more of the copper species further comprise (e.g., as an alloy with the copper in the copper species) one or more additional non-copper metals (e.g., gold, silver, platinum, rhodium, palladium, zirconium, or a combination thereof).
Statement 6. The material of any of the preceding Statements, wherein the material catalyzes a nitrogen oxide decomposition reaction (e.g., deNₓO_{y} reaction, wherein x and y are independently 1 or 2, but not simultaneously 2).
Statement 7. A method of synthesizing a material of any one of the preceding Statements comprising:
   a) adding (e.g., suspending) CeO₂ (e.g., cerium oxide particles) in an aqueous medium (e.g., water such as, for example, deionized water);
   b) adding an aqueous-soluble copper salt (e.g., copper nitrate, copper chloride) to the aqueous medium from a) (e.g., CeO₂ suspension from a)) to form a mixture;
   c) adding an excess of a salt (e.g., a soluble salt) comprising an anion (e.g., carbonate anion or hydroxide) (e.g., sodium carbonate, sodium hydroxide) that forms an insoluble copper (e.g., copper(II)) salt to the mixture from b), wherein an insoluble copper (e.g., copper(II)) salt and/or copper hydroxide precipitates on at least a portion of a surface of at least a portion of the CeO₂ (e.g., cerium oxide particles) to form a solid product material;
   d) isolating (e.g., by filtration) the solid product material from c);
   e) optionally, calcining (e.g., heating in air at, for example, 400° C. for 3 hours (heating ramp 2° C./min)) the solid product material from d); and
   f) optionally, graining the solid product from e) to form a material of any of the preceding claims.
Statement 8. A method of decomposing one or more nitrogen oxides (e.g., NₓO_{y}, wherein x and y are independently 1 or 2, but not simultaneously 2) using the material of any one of claims 1-6 or a material made by the method of Statement 7:
   a) contacting (e.g., flushing the atmosphere in which the material is present) the material of any one of Statements 1-4 or a material made by the method of Statement 5with a gas comprising 0 to 10% H₂ (e.g., 0.001% by volume to 100% by volume) in an environment at a temperature of 150° C. to 800° C.;
   b) returning (e.g., cooling) the material from a) to room temperature (e.g., 18-25° C.);
   c) contacting the material from b) (e.g., flushing the atmosphere in which the material is present) with helium gas;
   d) heating the material from c) to a temperature of 300° C. to 800° C.;
   e) contacting the material from d) with the one or more nitrogen oxides (e.g., NₓO_{y}, wherein x and y are independently 1 or 2, but not simultaneously 2) at 30° C. to 800° C., wherein at least a portion of the one or more nitrogen oxides (e.g., NₓO_{y}, wherein x and y are independently 1 or 2, but not simultaneously 2) are decomposed (e.g., to form nitrogen gas and oxygen gas).
Statement 9. The method of Statement 8, wherein the material of any of the preceding claims comprises nanoparticles having at least one active site (e.g., oxygen vacancy).
Statement 10. The material of Statement 9, wherein a plurality of active sites (e.g., subnanometer active sites) are highly dispersed (e.g., are discrete active sites) on the nanoparticles.
Statement 11. The method of any one of Statements 8-10, wherein at least a portion of the decomposed one or more nitrogen oxides (e.g., NₓO_{y}, wherein x and y are independently 1 or 2, but not simultaneously 2) are isolated from the material.
Statement 12. The method of any one of Statements 8-11, wherein the material from e) is contacted (e.g., at a temperature of 300° C. to 800° C. for certain time (e.g., 0.5 h to 10 h)) with a gas comprising hydrogen (e.g., a gas comprising 0.001% by volume to 100% by volume H₂ (e.g., 5% H₂)) or CO gas, wherein at least a portion of the copper in the material is reduced to copper metal.
Statement 13. The method of Statement 12, wherein the material from Statement 12 is used in b) in any one of claims 8-11.
Statement 14. The method of any one of Statements 8-13, wherein the method is carried out as a continuous process.

The following examples are presented to illustrate the present disclosure. They are not intended to limiting in any matter.

### EXAMPLE 1

This example provides a description of synthesis and use of Cu/CeO₂ catalysts of the present disclosure.

NOₓ exhaust gas, including NO, N₂O and NO₂, is a major pollutant gas emitted from automobiles and power plants using coal as fuel, which has caused severe environmental issues including acid rain and photochemical smog. At the condition of direct NOₓ decomposition, no reducing agent such as ammonia or hydrocarbons is required for the reduction of nitric oxide, which has been considered as the most applicable approach so far. The chemical formula for such reaction in the present disclosure can be represented as 2NO→N₂+O₂. Direct NOₓ decomposition in an efficient deNOₓ pathway.

Direct NOₓ decomposition is achieved in the present disclosure by new hydrogen reduction and helium thermal pretreatment methods for activation of robust deNOₓ activity of 2 wt % to 8 wt % copper loading on ceria catalyst. Cu/CeO₂ catalysts were prepared by precipitation of finely dispersed copper species over ceria nanoparticles. The obtained solid sample is calcined and grained. Under the hydrogen reduction and helium thermal treatment conditions of the present disclosure, catalysts are activated and exhibited effective deNOₓ ability. After deactivation, the Cu/CeO₂ catalyst can be easily regenerated by H₂ or CO. Even in the presence of O₂, the Cu/CeO₂ catalyst shows desirable deNOₓ performance.

In order to establish the catalytic activity of copper ceria catalysts, a series of tests were performed on direct NO and N₂O reactions at temperatures from 30° C. to 300° C., the catalytic reaction results were detected by Infrared Spectroscopy with fixed 5 m gas cell and Gas Chromatography-Barrier Ionization Discharge (GC-BID). The structures of the catalysts were characterized by transmission electron microscope (TEM), X-ray diffraction (XRD).

Activity of the catalyst on deNOₓ reaction was tested at temperatures ranging from 30° C. to 300° C. for activating copper ceria catalysts under the condition of direct NOₓ decomposition, deNOₓ activity can be achieved as low as 30° C. Under 300° C., the prepared copper ceria catalysts, which underwent the above pretreatment method, can achieve full conversion of NO for about 20 hours. The deactivated catalyst can be reactivated by hydrogen or CO regeneration and reused in a deNOₓ reaction, even in the presence of O₂.

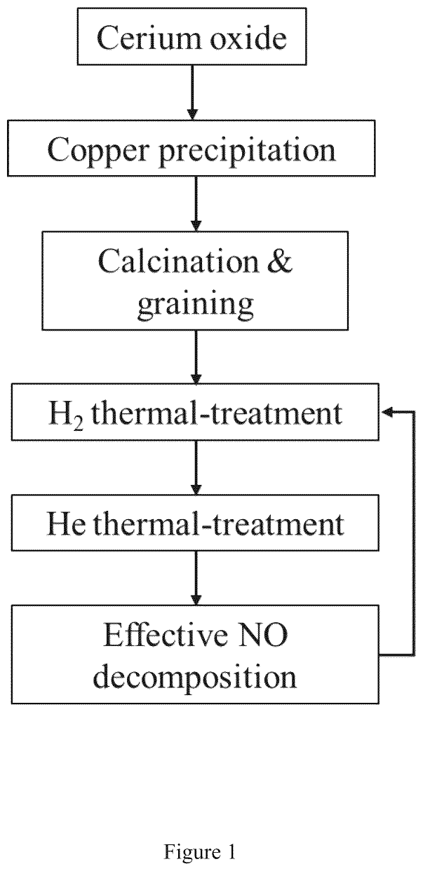

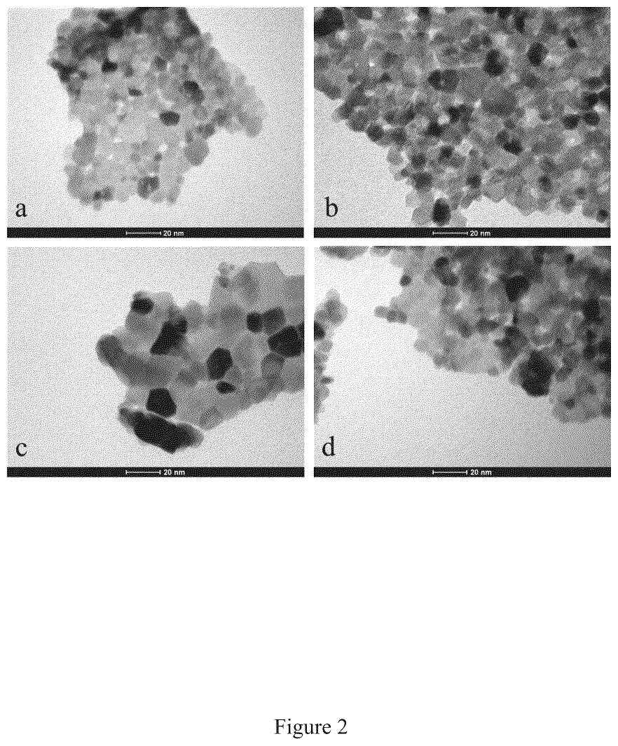

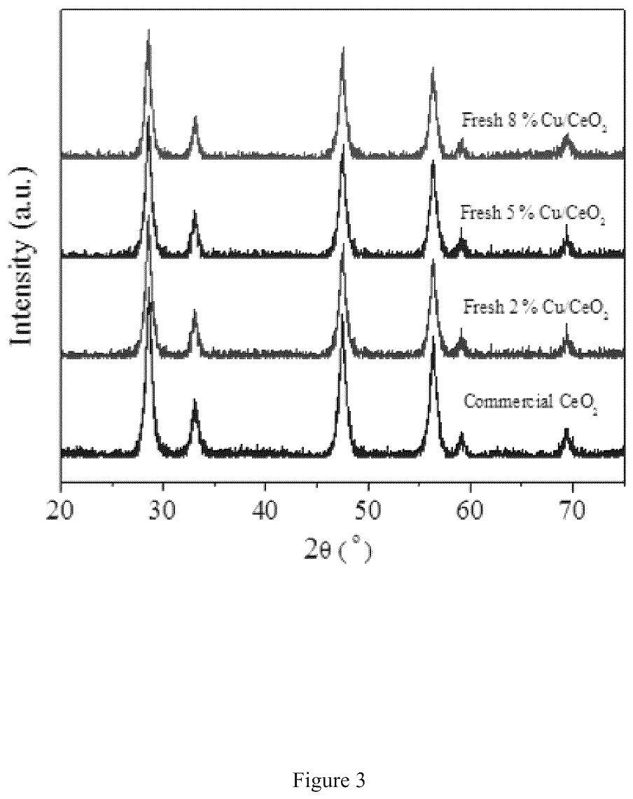

The Cu/CeO₂ catalysts were prepared via a precipitation method of different loadings (0 wt % to 8 wt %) of Cu on CeO₂ nanoparticles, detailed results can be found in FIG. 1. In a typical synthesis, CeO₂ was mixed in water with copper nitrate, an excess amount of sodium carbonate was added to precipitate copper into copper carbonate. The solution was filtered to obtain solid product. The solid was calcined and grained. The catalysts were characterized by transmission electron micrograph (TEM) and X-ray Diffraction (XRD). The characterization results showed sizes of support CeO₂ nanoparticles were around 10 nm to 30 nm, and the Cu species were highly dispersed on CeO₂. Detailed are shown in FIG. 2 and FIG. 3.

### EXAMPLE 2

This example provides a description of pretreatment of Cu/CeO₂ catalysts.

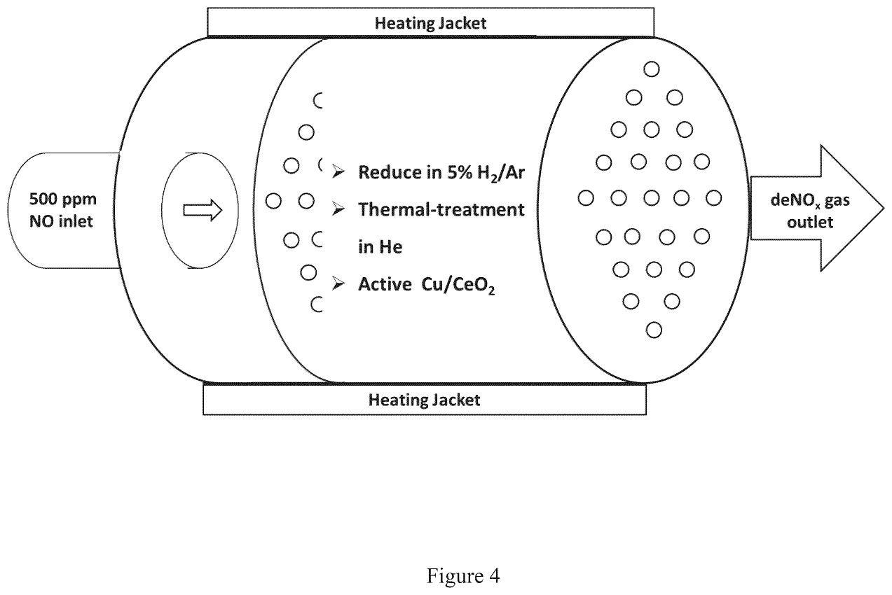

The catalyst pretreatment procedures in the present disclosure were carried out with hydrogen reduction followed by helium thermal treatment. In typical pretreatments, 0% to 10% hydrogen was flushed over the Cu/CeO₂ catalyst at 300° C. to 500° C. After H₂ reduction, the temperature was cooled down to room temperature, pure helium gas was flushed over the catalyst to remove physical adsorbed H₂, then increasing temperature to 300° C. to 500° C. to remove chemically adsorbed H₂. Detailed results are shown in FIG. 4.

### EXAMPLE 3

This example provides a description of the catalytic reaction results of NO decomposition using different catalysts.

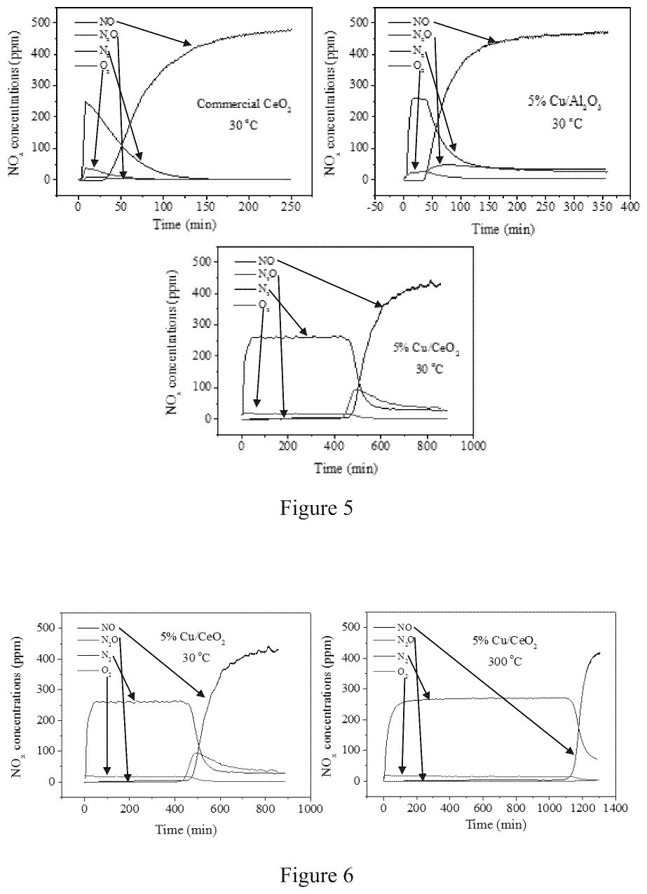

Catalytic reaction results of NO decomposition over commercial CeO₂, Cu/Al₂O₃ and Cu/CeO₂ series catalysts of the present disclosure can be compared in FIGS. 5 to 9 and described in following examples, respectively. In a typical reaction, 500 ppm NO gas is flushed over the activated catalyst with flowing rate at 20 ml/min in the packed bed. Conversion results were recorded by IR with a fixed 5 m gas cell and GC-BID. Summarized conversion and selectivity results can be viewed in Table 1.

TABLE 1
Direct NO decomposition on different catalysts pretreated by hydrogen
reduction and subsequent helium thermal treatment at 500° C.

| | T | Time | Time |
|---|---|---|---|
| Catalysts | (° C.)^{a} | (mins)^{b} | (mins)^{c} |
| Commercial CeO₂ | 30 | 30 | 8 |
| CeO₂ nanorods | 30 | 250 | 200 |
| 5% Cu/Al₂O₃ | 30 | 35 | 35 |
| 5% Cu/CeO₂ | 30 | 450 | 450 |
| 5% Cu/CeO₂ | 300 | 1100 | 1100 |
| 2% Cu/CeO₂ | 300 | 390 | 390 |
| 8% Cu/CeO₂ | 300 | 560 | 560 |

^{a}Reaction Temperature
^{b}Time window for 100% NO conversion
^{c}Time window for 100% N₂ selectivity

### EXAMPLE 4

This example provides a description of the use of different catalysts.

Commercial CeO₂, 5% Cu/Al₂O₃ and 5% Cu/CeO₂ catalysts underwent the activation pretreatment described in Example 2. These catalysts were compared as catalysts for direct NO decomposition at 30° C. All three catalysts achieved 100% NO conversion and 100% N₂ selectivity. But CeO₂, 5% Cu/Al₂O₃ and 5% Cu/CeO₂ catalysts showed different catalytic lifetimes, which were 30, 35, and 450 mins, respectively, indicating that synergistic effects between Cu and CeO₂ not only had good capacity of NO decomposition, but also was able to retard the deactivation of Cu/CeO₂. Detailed results are shown in FIG. 5.

### EXAMPLE 5

This example provides a description of use of different catalysts.

5% Cu/CeO₂ underwent pre-described activation pretreatment was used as catalyst for direction NO decomposition at 30° C. and 300° C. At 30° C., the catalyst achieved 100% NO conversion for 450 mins. 100% N₂ selectivity lasted for 450 mins. At 300° C., the catalyst achieved 100% NO conversion for 1100 mins. 100% N₂ selectivity lasted for 1100 mins. The comparison indicated that relatively high temperature could prolong the lifetime of the catalyst. Detailed results are shown in FIG. 6.

### EXAMPLE 6

This example provides a description of use of different catalysts.

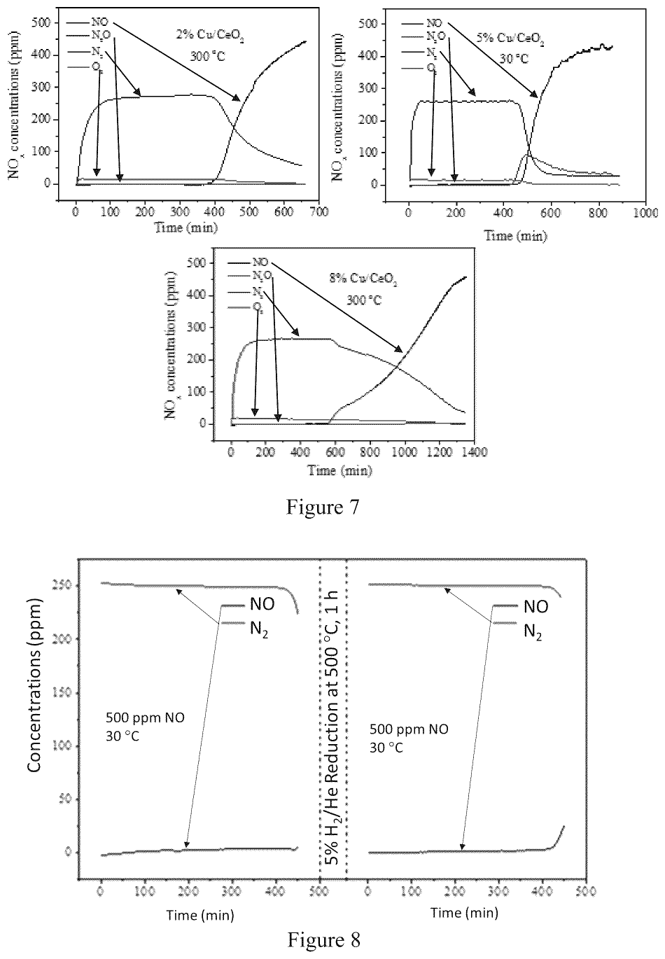

2% Cu/CeO₂, 5% Cu/CeO₂, and 8% Cu/CeO₂ catalysts underwent the activation pretreatment described in Example 2 and were used as catalyst for direct NO decomposition at 300° C. The lifetime of these catalysts were 390, 1100, and 560 mins, respectively. These data indicate that 5% Cu loading was optimal for NO decomposition. Detailed results are shown in FIG. 7.

### EXAMPLE 7

This example provides a description of catalyst regeneration.

5% Cu/Ce₂O₃ underwent the activation pretreatment described in Example 2 and was used as a catalyst for direct NO decomposition at 30° C. After deactivation, the catalyst was regenerated by 5% H₂ and the catalytic activity recovered. The regenerated catalyst achieved 100% NO conversion for nearly 450 mins. 100% N₂ selectivity lasted for 450 mins. Detailed results are shown in FIG. 8.

### EXAMPLE 8

This example provides a description of the effect of oxygen on methods of present disclosure.

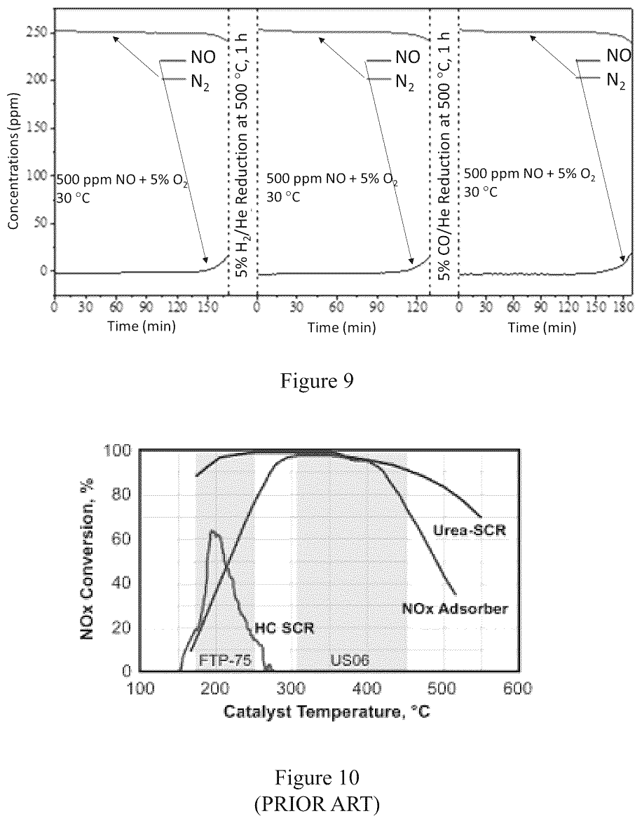

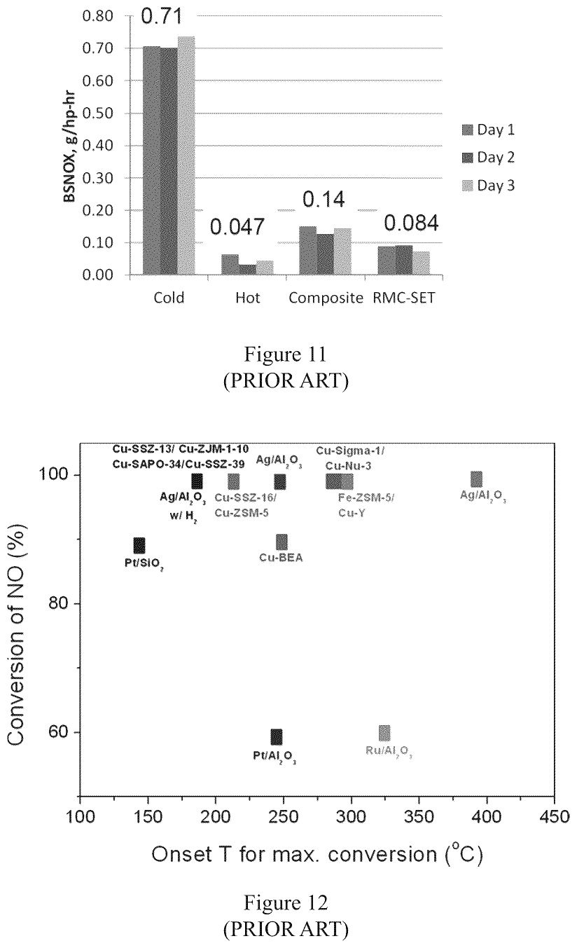

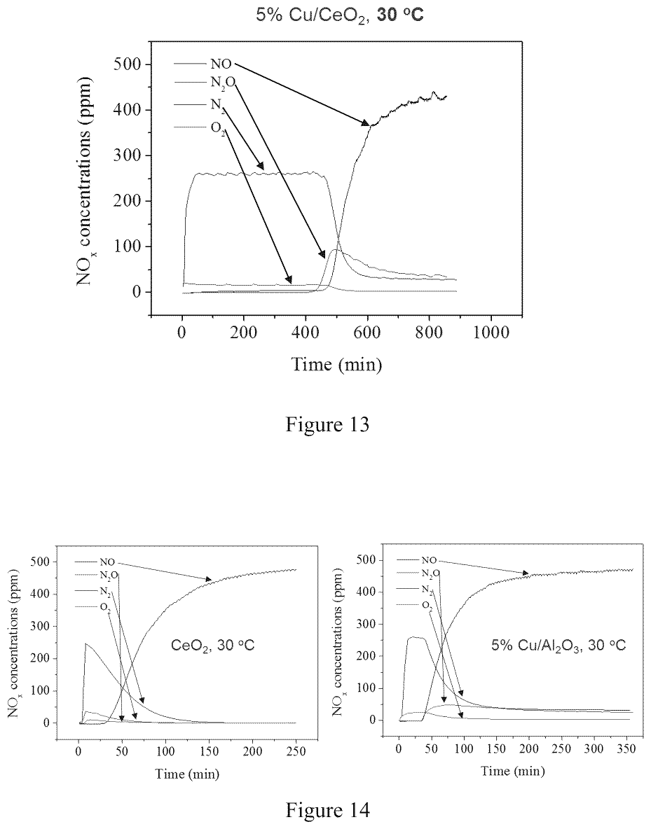

The effect of oxygen was investigated. Oxygen is a typical component in emissions of automobiles and power plants. 5% O₂ was added into direct NO decomposition at 30° C. over 5% Cu/Ce₂O₃, which underwent the activation pretreatment described in Example 2. The addition of oxygen accelerated the deactivation of catalyst from 450 mins to 150 mins. However, the catalyst was regenerated by 5% H₂ or CO. The activity and lifetime were recovered via regeneration. Detailed results are shown in FIG. 9.

### EXAMPLE 9

This example provides a description of industrial application of catalysts of the present disclosure.

The catalyst and methods can be used in an industrial design/system of application of a deNOₓ system. An example of such a design is shown FIG. 4.

FIG. 4 illustrates reaction conditions. Cu/CeO₂ series catalyst of the present disclosure are synthesized and loaded into the packed bed of the reactor system. To activate the catalyst, hydrogen reduction is implemented followed by helium pretreatment which was described in Example 2. The reactor is adjusted to its optimum temperature depending on operating conditions. The NO inlet is opened after catalysts are activated and hydrogen or helium inlets are closed. After the catalyst is deactivated, the NO inlet can be closed and catalyst is reactivated with hydrogen. A parallel alignment of this reactor design can be implemented to ensure sufficient amount of activated catalysts are operational for continuous NOₓ decomposition.

### EXAMPLE 10

This example provides a description of uses of nanoparticles of the present disclosure.

NOₓ can be decomposed using Cu/CeO₂ at room temperature. Activation of Cu/CeO₂ requires H₂ gas, presumably to produce oxygen vacancy. At room temperature, Cu/CeO₂ exhibits 100% of NO to N₂. The reaction, however, yields less O₂ than would be stoichiometrically predicted, presumably because of a redox reaction between Cu/CeO₂ and NO. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, and finally decomposition of NO via 500 ppm NO/He at room temperature at a rate of 20 mL/min. See FIG. 13.

NO decomposition was determined using CeO₂ and Cu/Al₂O₃ as controls. CeO₂ or Cu/Al₂O₃ shows some NO conversion, but not than longer than 50 minutes. It is considered that activity of Cu/CeO₂ is not because of a redox reaction, but rather it is due to unique interfacial sites and/or synergistic effects. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, and finally decomposition of NO via 500 ppm NO/He at room temperature at a rate of 20 mL/min. See FIG. 14.

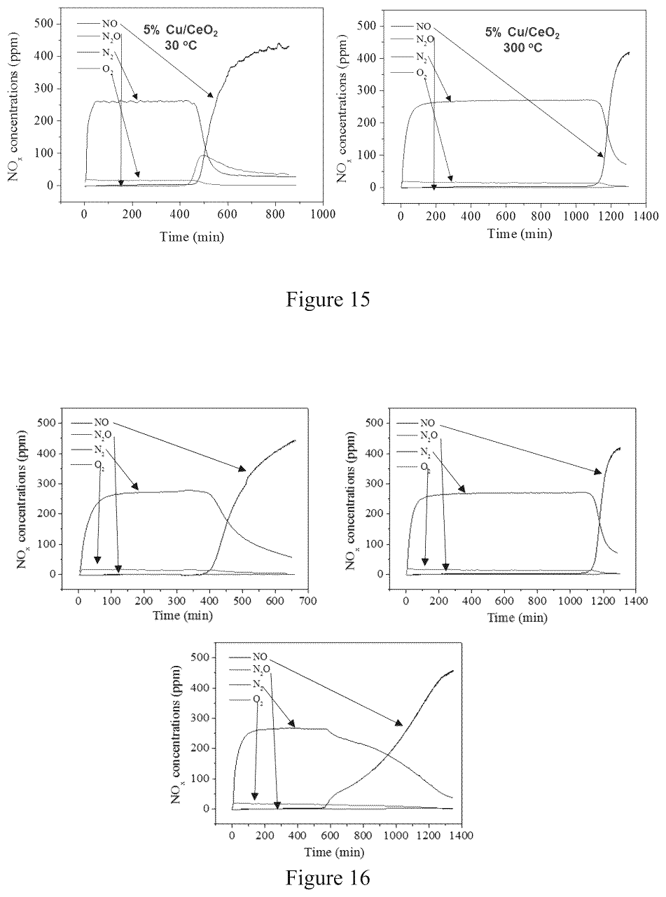

To determine if temperature affected the catalytic capacity of Cu/CeO₂, the catalyst was subjected to similar conditions as described above, but at 300° C. during NO treatment. The catalyst remained active for 1200 minutes at 300° C. O₂ stoichiometry was still lower than predicted; however, conversion of NO to N₂ was still 100%. The degradation was not due to oxidation of the catalysts because oxidation should have occurred faster at 300° C. than at room temperature. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, and finally decomposition of NO via 500 ppm NO/He at room temperature or 300° C. at a rate of 20 ml/min. See FIG. 15.

Further, it was determined that 5% copper loading achieved desirable results. These data indicate there is no reduction of NO by Cu, one would expect higher loading would yield a longer lifetime. See FIG. 16. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, and finally decomposition of NO via 500 ppm NO/He at room temperature at a rate of 20 mL/min.

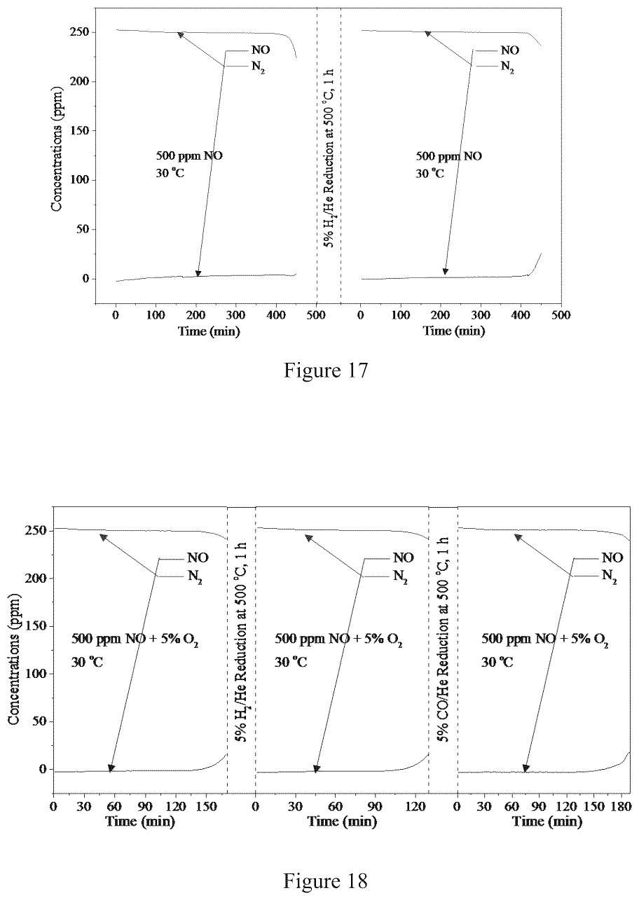

It was determined that the catalyst could be regenerated by H₂ treatment. Presumably this restores oxygen vacancy. It is expected that lower temperature (e.g., 300° C.) would work for regeneration. See FIG. 17. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, decomposition of NO via 500 ppm NO/He at room temperature at a rate of 20 mL/min, a regeneration cycle of 5% H₂/He, at 500° C. at a rate of 50 mL/min for 1 hour. Following regeneration, the catalyst was used for NO decomposition using 500 ppm NO at room temperature at a rate of 20 mL/min.

Cu/CeO₂ can selectively decompose NO in the presence of extra O₂. This reduces the lifetime of the catalyst; however, it can be regenerated by using H₂ or CO. See FIG. 18. The conditions used were an activation cycle of 5% H₂/He at 500° C. at a rate of 50 mL/min for 2 h, followed by another activation cycle of He at room temperature at a rate of 50 mL/min for 3 h, followed by another activation He from room temperature to 500° C. at 50 mL/min for 2 h, decomposition of NO via 500 ppm NO and 5% O₂ at room temperature at a rate of 20 mL/min. Conditions for regeneration include 5% H₂/He at 500° C. at a rate of 50 mL/min for 1 h or % CO/He at 500° C. at a rate of 50 mL/min for 1 h. After either cycle of regeneration, NO decomposition activity was 100% recovered.

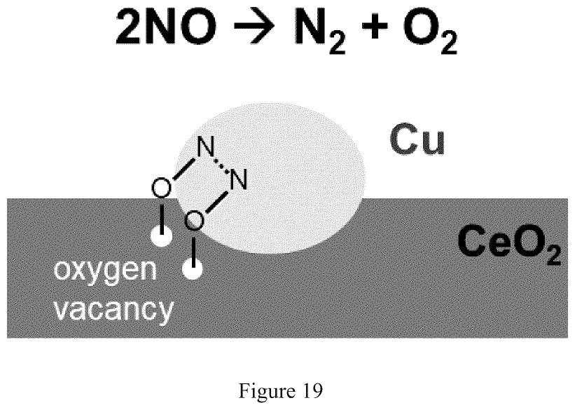

It is considered that the catalytic mechanism of Cu/CeO₂ is based on interplay between Cu surface and oxygen vacancy at the Cu/CeO₂ interface generates active sites for NO decomposition. A shorter distance between neighboring oxygen vacancies provides stronger compression between NO_{ad} than Cu-ZSM-5. Further, degradation caused by the undesired side reaction: produced O₂ fill in the oxygen vacancy. See FIG. 19.

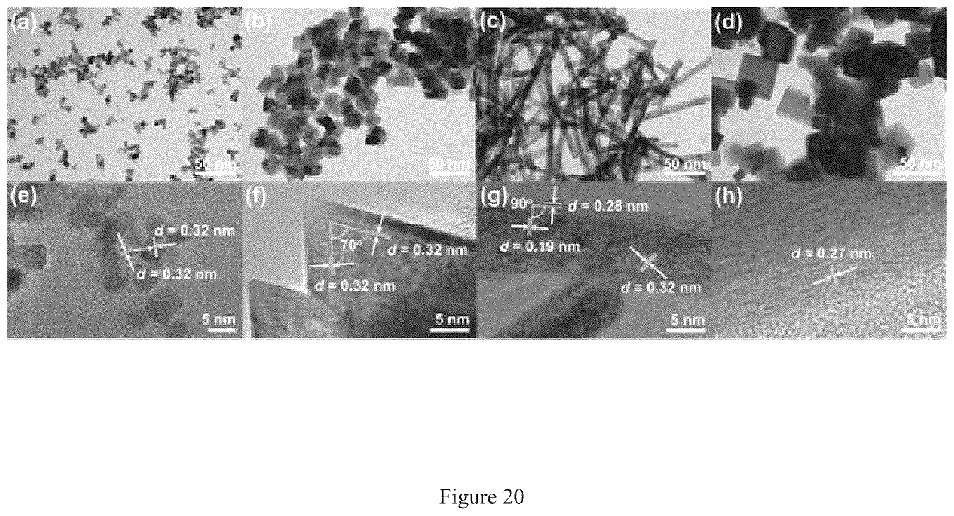

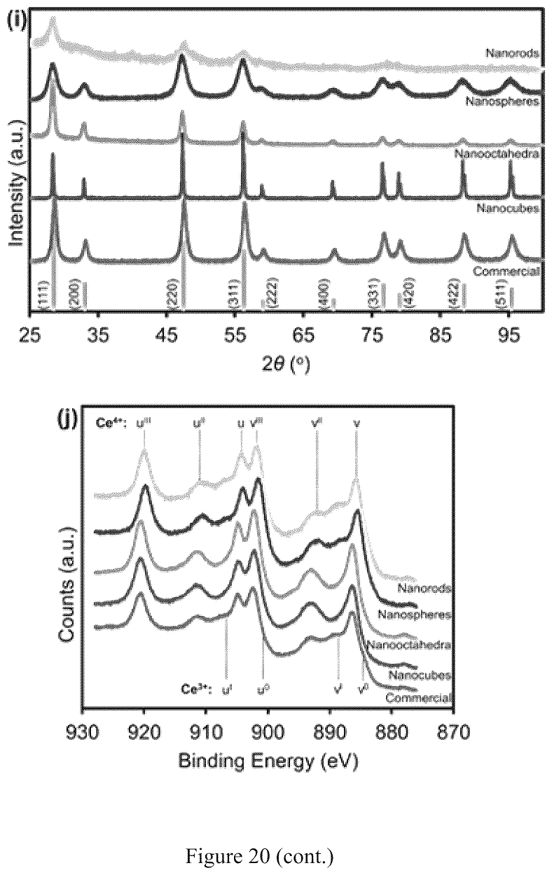

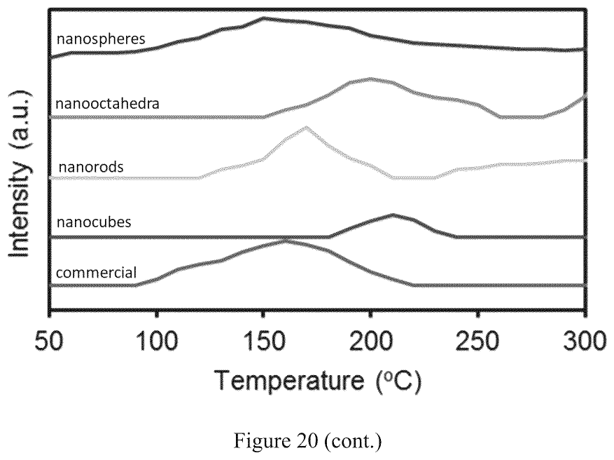

FIG. 20 shows examples of catalyst morphology (e.g., nanoparticles and nanorods) and composition (e.g., doped CeO₂ nanoparticle compositions and copper species alloys).

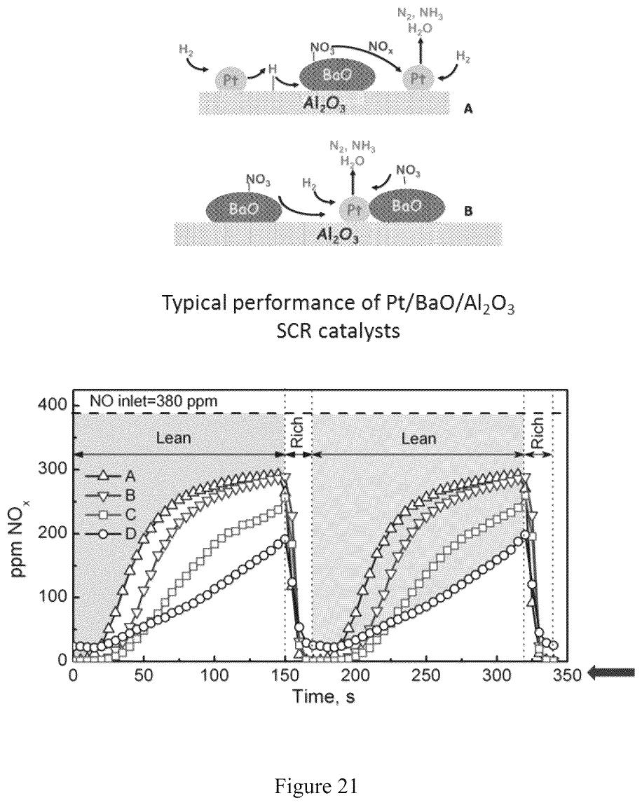

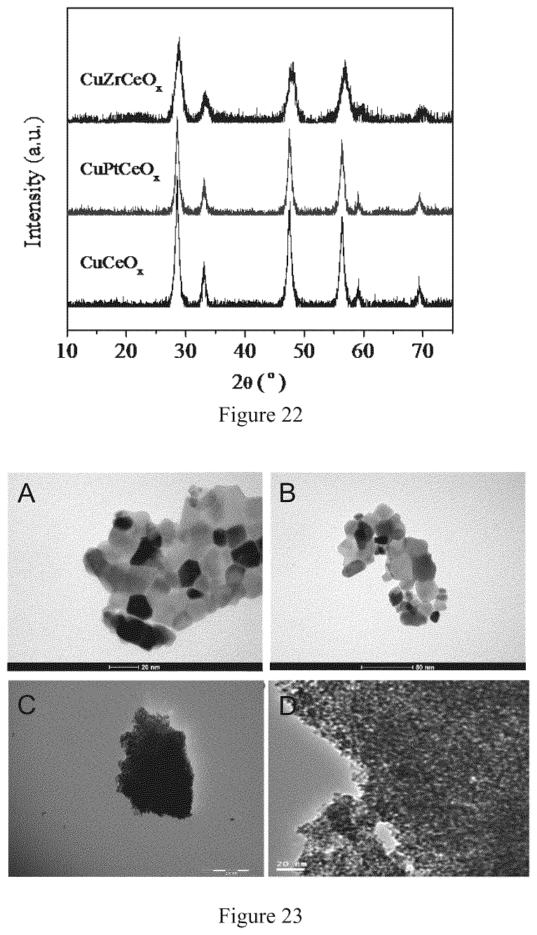

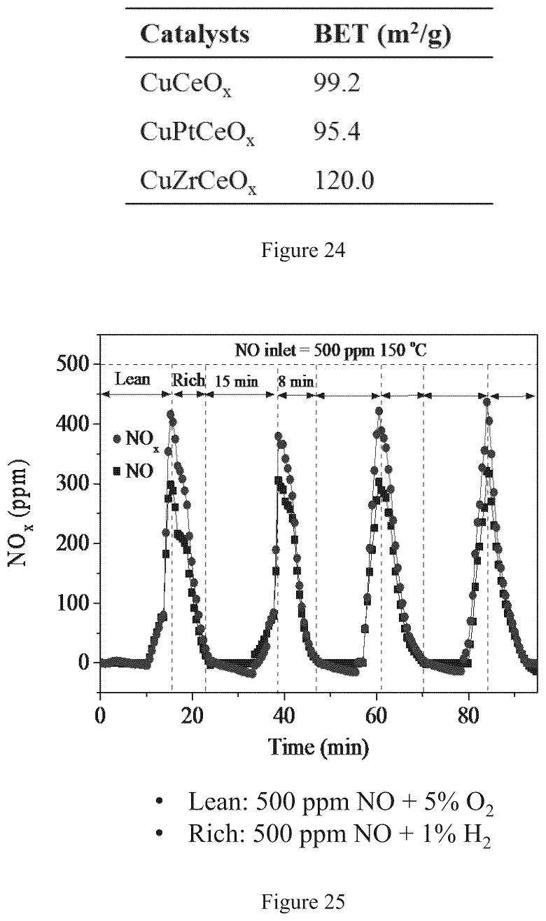

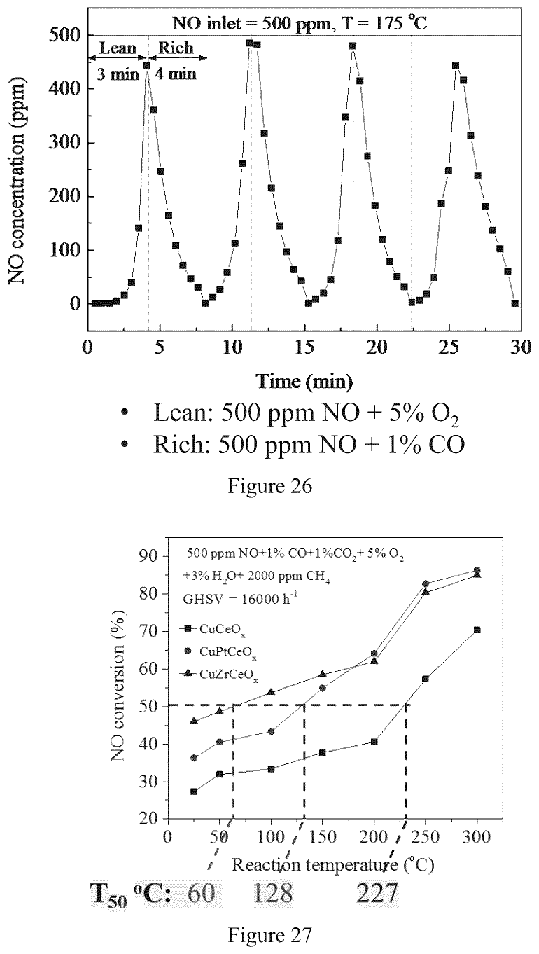

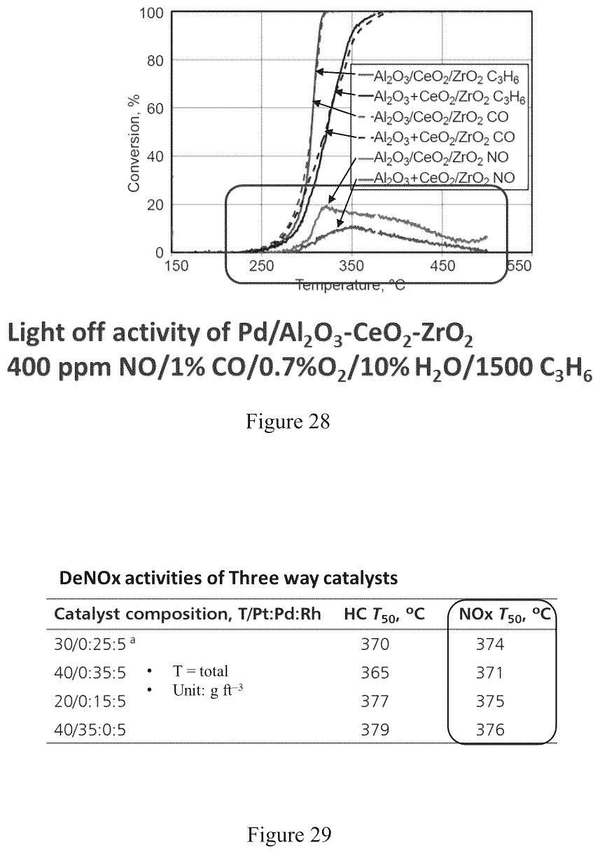

FIG. 21 shows use of catalysts in NSR-type operations. This would include reactivation of the catalyst using alternative lean-rich combustion conditions, storing O₂, making it active at room temperature, and increasing the lifetime. Further, SCR using H₂, CO, CHₓ, NH₃.

Although the present disclosure has been described with respect to one or more particular embodiments and/or examples, it will be understood that other embodiments and/or examples of the present disclosure may be made without departing from the scope of the present disclosure.

1. A material comprising one or more nanoparticles, wherein the nanoparticles are CeO₂ nanoparticles having domains of one or more copper species disposed on at least a portion of a surface of the CeO₂ nanoparticles.

2. The material of claim 1, wherein the copper species comprises aqueous-insoluble copper(II) salts, copper oxide, copper hydroxide, or a combination thereof.

3. The material of claim 1, wherein the copper is present at 0.001% by weight to 8% by weight based on the total weight of the nanoparticle(s).

4. The material of claim 3, wherein the copper present is at 2% by weight to 8% by weight based on the total weight of the nanoparticle(s).

5. The material of claim 3, wherein the copper is present at 4% by weight to 6% by weight based on the total weight of the nanoparticle(s).

6. The material of claim 1, wherein the nanoparticles have a longest dimension of 10 nm to 30 nm.

7. The material of claim 1, wherein the nanoparticles are spherical or nanorods.

8. The material of claim 1, wherein one or more of the copper species further comprise one or more additional non-copper metals.

9. The material of claim 8, wherein the one or more copper species and additional one or more additional non-copper metals are present as an alloy.

10. The material of claim 8, wherein the one or more additional non-copper metals comprise gold, silver, platinum, rhodium, palladium, zirconium, or a combination thereof.

11. A method of synthesizing a material of claim 1, comprising:
a) adding CeO₂ in an aqueous medium;
b) adding an aqueous-soluble copper salt to the aqueous medium from a) to form a mixture;
c) adding an excess of a salt comprising an anion that forms an insoluble copper salt to the mixture from b), wherein an insoluble copper salt and/or copper hydroxide precipitates on at least a portion of a surface of at least a portion of the CeO₂ to form a solid product material;
d) isolating the solid product material from c);
e) optionally, calcining the solid product material from d); and
f) optionally, graining the solid product from e), wherein the material is formed.

12. A method of decomposing one or more nitrogen oxides using the material of claim 1:
a) contacting the material of claim 1 with a gas comprising 0.001 to 10% H₂ by volume in an environment at a temperature of 150° C. to 800° C.;
b) returning the material from a) to room temperature;
c) contacting the material from b) with helium gas;
d) heating the material from c) to a temperature of 300° C. to 800° C.;
e) contacting the material from d) with the one or more nitrogen oxides at 30° C. to 800° C., wherein at least a portion of the one or more nitrogen oxides are decomposed.

13. The method of claim 12, wherein the material comprises nanoparticles having at least one active site.

14. The material of claim 13, wherein a plurality of active sites are highly dispersed on the nanoparticles.

15. The method of claim 12, further comprising isolating at least a portion of the decomposed one or more nitrogen oxides.

16. The method of claim 12, further comprising contacting the material from e) with a gas comprising hydrogen or CO gas, wherein at least a portion of the copper in the material is reduced to copper metal.

17. The method of claim 16, wherein the material contacted with a gas comprising hydrogen or CO gas is used in b).

18. The method of claim 11, wherein the method is carried out as a continuous process.
